(19) United States
(12) Patent Application Publication
(10) Pub. No.: US 2005/0121376 A1
(43) Pub. Date: Jun. 9, 2005

(54) Fuel filter with self-heating device

(75) Inventor: Giorgio Girondi, Mantova (IT)

Correspondence Address: BROWDY AND NEIMARK, P.L.L.C.;624 NINTH STREET, NW, SUITE 300, WASHINGTON, DC, 20001-5303, US

(73) Assignee: UFI Filters S.P.A.

(21) Appl. No.: 10/503,237

(22) PCT Filed: Mar. 3, 2003
(86) PCT No.: PCT/EP03/02220

(30) Foreign Application Priority Data
Mar. 8, 2002 (IR) RE02A000022

(51) Int. Cl. B01D 35/18

(52) U.S. Cl. 210/175

(57) ABSTRACT

A fuel filter (1) comprising a cup shaped outer casing (2) provided in its wall with a fuel exit conduit (21), and closed by a cover provide with an axial fuel feed conduit (41) with which a filter cartridge (3) of toroidal form is associated coaxial to said axial conduit and is sealedly mounted thereon; an elongate container (5) containing a substance able to develop an exothermic reaction is provided in the cavity of the filter cartridge.

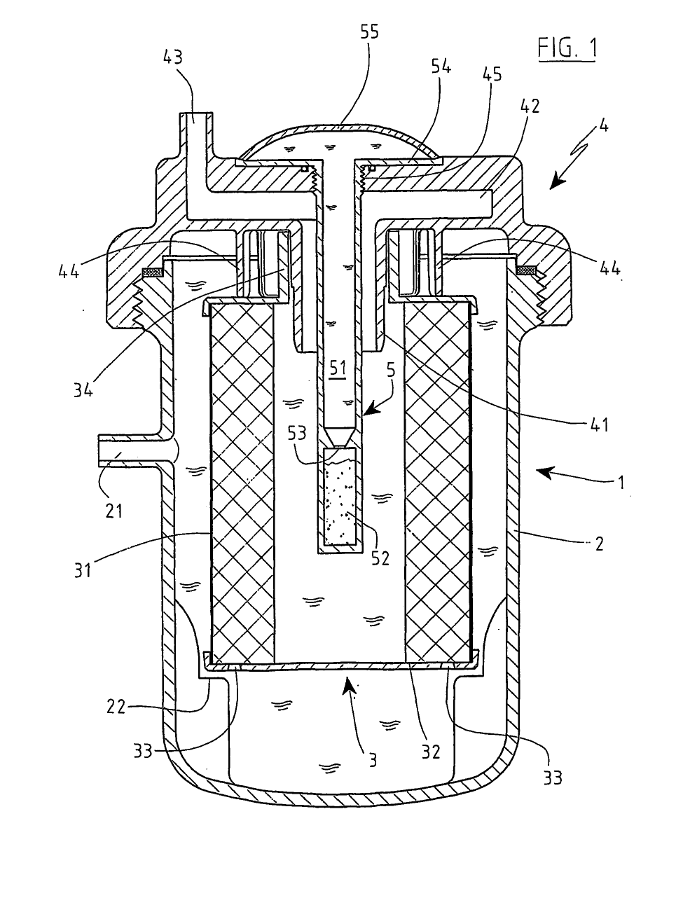

### TECHNICAL FIELD

This invention relates to fuel filters present in diesel engines.

### BACKGROUND ART

The fuel used in such engines contains components, such as paraffin, which tend to thicken to the point of solidifying at low temperature.

The presence of a filter is essential to remove the impurities present in the fuel before it is fed to the injection devices, hence if the engine remains inactive for a certain time at a very low temperature of less than −25° C., it becomes impossible to start it because of filter blockage by said components.

The problem of filter blockage due to low temperature arises only on starting, because the diesel oil pumped at high pressure is subjected to sufficient self-heating to prevent separation of components in the solid state, such as the said paraffin.

The problem which has to be overcome is hence limited to that fuel which when the engine is stationary lies within the filter itself and in that conduit between the feed pump and the filter.

Said fuel quantity is generally of the order of 30 cm³ and 1300-1600 cm³ respectively.

To ensure correct engine start, this fuel must be brought to a temperature not less than −10° C.

In the known art, when the temperature is so low as not to enable the engine to be started, it is known to heat the fuel filter from the outside using external means, such as hot water, so enabling the diesel fuel contained therein to be used.

On starting the engine, heating means contained within the filter cover are activated, these generally consisting of a resistance element powered by the vehicle battery.

After a short period of operation, generally between 30 and 50 seconds, said means are deactivated and the engine continues to operate normally.

The heating means can be activated only after the engine has started, because the current absorption is such as to rapidly discharge the battery if the engine is not running.

The object of the present patent is to remedy the said drawback by a simple and economical solution.

Said object is attained by a device having the characteristics defined in the claims.

Essentially, this comprises a container of elongate shape to be inserted, and fixed in situ, through a central hole in the filter cover.

Said container is intended to be inserted into the central cylindrical cavity of the filter cartridge, to occupy a substantial axial portion thereof.

The container comprises at least one pair of compartments separated by a diaphragm which can be broken by external action.

One of said compartments contains a first solid reactant substance, such as calcium chloride CaCl₂, able to generate a strongly exothermic reaction when brought into contact with a second liquid reactant substance contained in the other compartment, such as an aqueous solution having a low freezing point.

Said reaction generates a quantity of heat sufficient to destroy the film of solidified or partly solidified component, such as paraffin, which has deposited on the filter surface while the engine has not been running.

The diaphragm which separates the two compartments of each pair of compartments is broken by acting from the outside, as stated.

In this embodiment, once the container has been used it is disposed of, and a new container is inserted into the cavity provided in the filter.

The invention also provides for the use of a container reusable indefinitely. In that case supersaturated supercooled liquid solutions are used to generate considerable quantities of heat in passing from the liquid state to the crystalline state.

A solution of sodium acetate trihydrate (CH₃COONa-3H₂O) has proved particularly suitable, this solidifying at around 58° C. and hence being in the liquid state at the diesel fuel temperature during normal engine operation.

The merits and the constructional and operational characteristics of the invention will be apparent from the ensuing detailed description of a preferred embodiment thereof, given by way of non-limiting example with reference to the accompanying FIGURE.

The FIGURE shows an axial section through a fuel filter according to the invention.

The filter 1 comprises a usual cup-shaped outer casing 2 provided with an exit conduit 21 for the filtered fuel and with fins 22 for supporting the filter cartridge 3.

The cartridge 3 is of toroidal form and presents an outer wall 31 impermeable to fuel, and a base 32 having a series of circumferential holes 32 in correspondence with the cartridge base.

The casing 2 is closed upperly by a profiled cover sealedly screwed onto the casing 2.

The cover 4 comprises an axial conduit 41 which extends downwards from a compartment 42 provided within the thickness of the cover.

The compartment 42 presents a conduit 43 which opens to the outside and through which the fuel to be filtered is fed.

External to the conduit 41 there are a series of concentric feet 44 arranged to rest against the top of the cartridge 3 to maintain it in position.

The cartridge 3 presents an upper axial conduit 34 to be sealedly fitted over the outside of the conduit 41.

At the centre of the cover there is provided a threaded seat 45 into which a cylindrical container 5 divided into two compartments 51 and 52 by a central diaphragm 53 is sealedly inserted.

The container 5 is conveniently constructed of nylon.

The diaphragm 53 is in the form of a thin sheet of aluminium glued in situ.

The container 5 upperly presents a wide top 54 above which there is a deformable wall 55.

The lower compartment 52 contains solid calcium chloride CaCl₂, whereas the upper compartment 51 contains distilled water in which a salt such as sodium chloride NaCl is dissolved in such a concentration as to lower its freezing point to below −45° C.

For a normal fuel filter, in which the capacity of the axial cavity of the cartridge is of the order of 30 cm³, the lower compartment 52 contains from 24 to 44 g of CaCl₂, and the upper compartment 51 contains from 20 to 40 cm³ of salt water or water containing a suitable antifreeze.

When the engine has to be restarted after a prolonged period of non-running at a temperature of the order of −40° C., the driver forcibly presses the deformable wall 55, so causing the diaphragm to break and the water to descend into the lower compartment in contact with the calcium chloride.

The exothermic reaction between the water and calcium chloride develops a quantity of heat sufficient to raise, within a very short time of the order of a few seconds, the temperature of the fuel contained in the central compartment of the filter to a temperature of the order of +10° C.

This enables the engine to be started and to run until the fuel contained in the conduit between the pump and filter has dispersed, it mixing with the fuel contained in the filter and lowering its temperature to a level not less than −10° C., sufficient to prevent separation of the paraffin component.

The container 5 is disposable, and after use is quickly replaced with a new one.

In addition to the sodium chloride, the usable salts include calcium chloride (CaCl₂), copper sulphate (CuSO₄), and magnesium sulphate (MgSO₄).

The following table shows the physical-chemical characteristics of the said salts by hydration.

| | Heat of hydration | Solubility |
|---|---|---|
| Salt | (J/g) | (G in 100 ml H₂O at 20° C.) |
| Calcium chloride | 678.7 | 74.5 |
| Copper sulphate | 416.8 | 20.7 |
| Magnesium sulphate | 706.8 | 26.2 |

The suggested reactant quantities to obtain solutions close to saturation and to maximize the content of solute which can be dissolved at 20° C. are the following:

| | |
|---|---|
| CaCl₂ in water | 42% by weight |
| MgSO₄ in water | 20% by weight |
| CuSO₄ in water | 16% by weight |

It is also suggested to use an antifreeze mixture of 50% water/50% glycol instead of water, with simultaneous salt reduction.

In the case of calcium chloride the content thereof in the mixture is conveniently 27% by weight.

For breaking the diaphragm a mechanical means such as a hollow punch known in packs of two-component pharmaceutical products can also be provided.

The solid reactant substance can be conveniently located in the punch interior, and the punch base can be closed by an aluminium sheet.

If supersaturated supercooled liquid solutions of sodium acetate trihydrate (CH₃COONa-3H₂O) are used it is not necessary to provide means for breaking the diaphragm in the disposable cartridge, as the heat generation on starting the engine is automatic, as stated.

A solution of 90% by weight of sodium acetate trihydrate in 10% by weight of water has been used successfully.

The compound is prepared by heating the reactants to a temperature less than the boiling point of water (about 80° C.).

The solution container is conveniently of polyethyene, and contains a thin metal sheet which facilitates the triggering of the liquid-solid transformation, by acting as a crystallization seed.

The physical-chemical characteristics of sodium acetate trihydrate are the following:

| | |
|---|---|
| heat of fusion | 264 (J/g) |
| heat of crystallization | 144 (J/g) |
| solubility of the salt | 46.5 g/100 g H₂O |

1. A fuel filter comprising a cup shaped outer casing provided in its wall with a fuel exit conduit, and closed by a cover provided with an axial fuel feed conduit with which a filter cartridge of toroidal form is associated coaxial to said axial conduit and is sealedly mounted thereon, characterised by comprising an elongate container which extends into the interior of the filter cartridge, in said container there being placed a substance able to develop an exothermic reaction.

2. A filter as claimed in claim 1, characterised in that the substance able to develop an exothermic reaction is a supersaturated solution of sodium acetate trihydrate.

3. A filter as claimed in claim 1, characterised in that said container is divided into a lower compartment for containing a first solid reactant substance, and an upper compartment for containing a liquid reactant substance, said compartments being separated by a diaphragm which can be fractured from the outside, said reactant substances being such as to cause an exothermic reaction.

4. A filter as claimed in claim 3, characterised in that said first reactant substance is chosen from calcium chloride CaCl₂, copper sulphate CuSO4 and magnesium sulphate MgSO4, and said second reactant substance is an aqueous solution having a freezing point lower than −40° C.

5. A filter as claimed in claim 4, characterised in that said second reactant substance is a mixture of water and glycol.

6. A filter as claimed in claim 4, characterised by containing from 24 to 44 g of calcium chloride CaCl₂, and from 20 to 40 cm³ of water.

7. A filter as claimed in claim 3, characterised in that said container presents a deformable wall accessible from the outside.

8. A filter as claimed in claim 3, characterised in that said container presents a mechanical hollow punch close to the diaphragm and operable from the outside.
